(19) United States
(12) Patent Application Publication
(10) Pub. No.: US 2019/0292017 A1
(43) Pub. Date: Sep. 26, 2019

(54) ANTI-DERAILMENT SYSTEMS FOR SLIDING DOORS

(71) Applicant: Otis Elevator Company, Farmington, CT (US)

(72) Inventor: Fabrice Hamon, Les Choux (FR)

(21) Appl. No.: 16/356,010

(22) Filed: Mar. 18, 2019

(30) Foreign Application Priority Data
Mar. 21, 2018 (EP) 18305313.1

(51) Int. Cl. B66B 13/08; E05D 15/06; B66B 13/30; B60J 5/06

(52) U.S. Cl. CPC B66B 13/08; E05D 15/0656; E05Y 2900/104; B60J 5/06; E05Y 2900/531; B66B 13/301

(57) ABSTRACT

Sliding door systems are provided herein. The sliding door systems include a sliding door having a panel base, a sill having a guide channel having a stop arranged within the guide channel, wherein the guide channel includes a first subchannel and a second subchannel, wherein the first subchannel is defined at least partially by the stop and wherein the stop defines a gap connecting the first subchannel to the second subchannel, and an anti-derailment system. The anti-derailment system includes a first member having a first end and a second end, wherein the first end extends into the first subchannel and the second end connects to the panel base and a second member attached to the first member, wherein the second member is positioned within the second subchannel of the guide channel.

### BACKGROUND

The subject matter disclosed herein generally relates to sliding doors and, more particularly, to anti-derailment systems for sliding doors, and in some embodiments, elevator system sliding doors.

Elevator systems include sliding doors, both of the elevator car and at the landings. Such doors must be structurally sound and securable to prevent unauthorized access to an elevator shaft of the elevator system. Locks and locking mechanisms are typically employed to secure the sliding landing doors of an elevator system to prevent unauthorized opening of the sliding doors. However, the sliding doors must also be designed to prevent forced opening, such as by impact to the doors. Accordingly, in typical systems, the landing doors (and elevator car doors) can be manufactured with stiffeners or other structural components that provide additional strength to the sliding doors. Such strength prevents impacts from pushing the sliding doors inward, and potentially having a portion of the landing door “jump” from a track through which the sliding door is guided. The stiffeners will add additional costs, weight, and installation considerations, and thus improved sliding doors may be advantageous.

### SUMMARY

According to some embodiments, sliding door systems are provided. The sliding door systems include a sliding door having a panel base, a sill having a guide channel having a stop arranged within the guide channel, wherein the guide channel includes a first subchannel and a second subchannel, wherein the first subchannel is defined at least partially by the stop and wherein the stop defines a gap connecting the first subchannel to the second subchannel, and an anti-derailment system. The anti-derailment system includes a first member having a first end and a second end, wherein the first end extends into the first sub channel and the second end connects to the panel base and a second member attached to the first member, wherein the second member is positioned within the second subchannel of the guide channel.

In addition to one or more of the features described above, or as an alternative, further embodiments of the sliding door systems may include that the first member includes a locking element at the first end, wherein the locking element is arranged to contact the stop during an impact to the sliding door.

In addition to one or more of the features described above, or as an alternative, further embodiments of the sliding door systems may include that the locking element does not contact the stop during normal operation.

In addition to one or more of the features described above, or as an alternative, further embodiments of the sliding door systems may include that the locking element is arranged to pass through the gap in a first orientation and is rotatable to a second orientation within the first subchannel.

In addition to one or more of the features described above, or as an alternative, further embodiments of the sliding door systems may include a securing mechanism, wherein the securing mechanism fixedly attaches the first member to the panel base.

In addition to one or more of the features described above, or as an alternative, further embodiments of the sliding door systems may include that the panel base includes a recess, wherein at least a part of the securing mechanism is received within the recess.

In addition to one or more of the features described above, or as an alternative, further embodiments of the sliding door systems may include that the securing mechanism comprises at least one of a locking nut system, a crimping nut system, and a lock-pin system.

In addition to one or more of the features described above, or as an alternative, further embodiments of the sliding door systems may include that the first member includes an indicator located at the second end, wherein the indicator indicates an orientation of the first member.

In addition to one or more of the features described above, or as an alternative, further embodiments of the sliding door systems may include that the indicator is aligned with at least a portion of the first end of the first member to indicate an orientation of the first end of the first member.

In addition to one or more of the features described above, or as an alternative, further embodiments of the sliding door systems may include that the panel base includes at least one inspection aperture positioned to enable visual inspection of at least a portion of the anti-derailment system.

In addition to one or more of the features described above, or as an alternative, further embodiments of the sliding door systems may include that the second end of the first member includes threads for engagement with at least one of the panel base and a securing mechanism.

In addition to one or more of the features described above, or as an alternative, further embodiments of the sliding door systems may include that a second anti-derailment system is installed to the panel base.

In addition to one or more of the features described above, or as an alternative, further embodiments of the sliding door systems may include that the second member frictionally engages within the second subchannel.

In addition to one or more of the features described above, or as an alternative, further embodiments of the sliding door systems may include that the sliding door is at least one of a landing door and an elevator car door of an elevator system.

In addition to one or more of the features described above, or as an alternative, further embodiments of the sliding door systems may include that the sliding door is a sliding door of a vehicle.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of an elevator system that may employ various embodiments of the present disclosure;

FIG. 2 is a schematic illustration of a landing door of an elevator system that may employ various embodiments of the present disclosure;

FIG. 3 is a schematic illustration of an anti-derailment system in accordance with an embodiment of the present disclosure;

FIG. 4 is a schematic illustration of a portion of an anti-derailment system in accordance with an embodiment of the present disclosure;

FIG. 5A is a schematic isometric illustration of a first member of an anti-derailment system in accordance with an embodiment of the present disclosure;

FIG. 5B is an alternative schematic isometric illustration of the first member shown in FIG. 5A;

FIG. 6 is a schematic isometric illustration of a second member of an anti-derailment system in accordance with an embodiment of the present disclosure;

FIG. 7A is a schematic illustration of a first orientation of a first member of an anti-derailment system in accordance with an embodiment of the present disclosure;

FIG. 7B is a schematic illustration of a second orientation of the first member shown in FIG. 7A;

FIG. 8A is a schematic illustration of a sliding door having multiple anti-derailment systems installed thereto; and

FIG. 8B is an alternative view of the sliding door shown in FIG. 8A.

### DETAILED DESCRIPTION

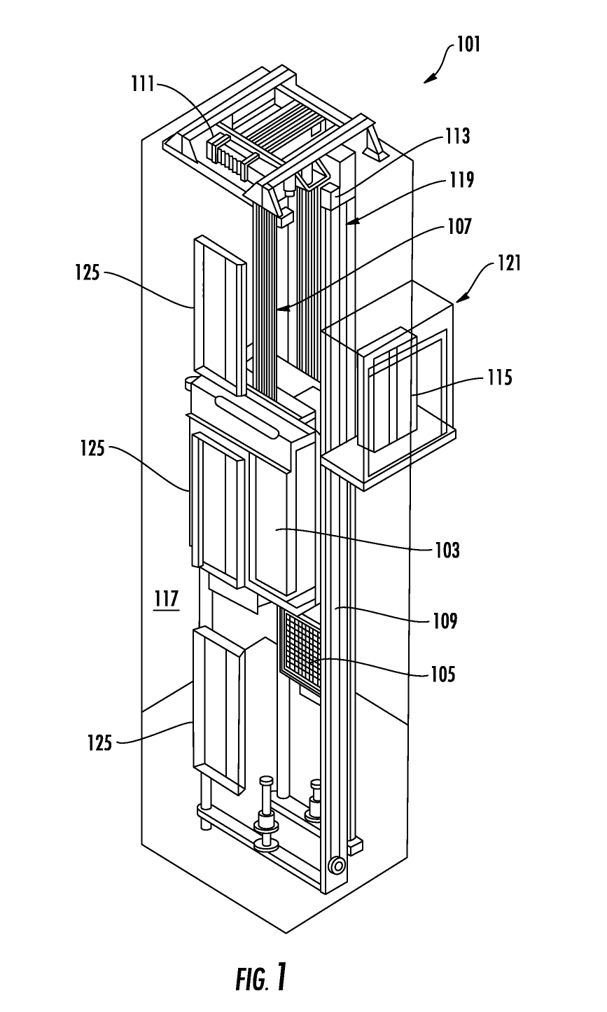

FIG. 1 is a perspective view of an elevator system 101 including an elevator car 103, a counterweight 105, a roping 107, a guide rail 109, a machine 111, a position encoder 113, and an elevator controller 115. The elevator car 103 and counterweight 105 are connected to each other by the roping 107. The roping 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The roping 107 engages the machine 111, which, in this illustrative embodiment, is part of an overhead structure of the elevator system 101, although other arrangements are possible without departing from the scope of the present disclosure. The machine 111 is configured to control movement between the elevator car 103 and the counterweight 105. The position encoder 113 may be mounted on an upper sheave of a speed-governor system 119 and may be configured to provide position signals related to a position of the elevator car 103 within the elevator shaft 117. In other embodiments, the position encoder 113 may be directly mounted to a moving component of the machine 111, or may be located in other positions and/or configurations as known in the art.

The elevator controller 115 is located, as shown in the illustrative arrangement, in a controller room 121 of the elevator shaft 117 and is configured to control the operation of the elevator system 101, and particularly the elevator car 103. In other embodiments the controller 115 can be located in other locations, including, but not limited to, fixed to a landing or landing door or located in a cabinet at a landing. The elevator controller 115 may provide drive signals to the machine 111 to control the acceleration, deceleration, leveling, stopping, etc. of the elevator car 103. The elevator controller 115 may also be configured to receive position signals from the position encoder 113. When moving up or down within the elevator shaft 117 along guide rail 109, the elevator car 103 may stop at one or more landings 125 as controlled by the elevator controller 115. Although shown in a controller room 121, those of skill in the art will appreciate that the elevator controller 115 can be located and/or configured in other locations or positions within the elevator system 101.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. Although shown and described with a roping system, elevator systems that employ other methods and mechanisms of moving an elevator car within an elevator shaft may employ embodiments of the present disclosure. FIG. 1 is merely a non-limiting example presented for illustrative and explanatory purposes.

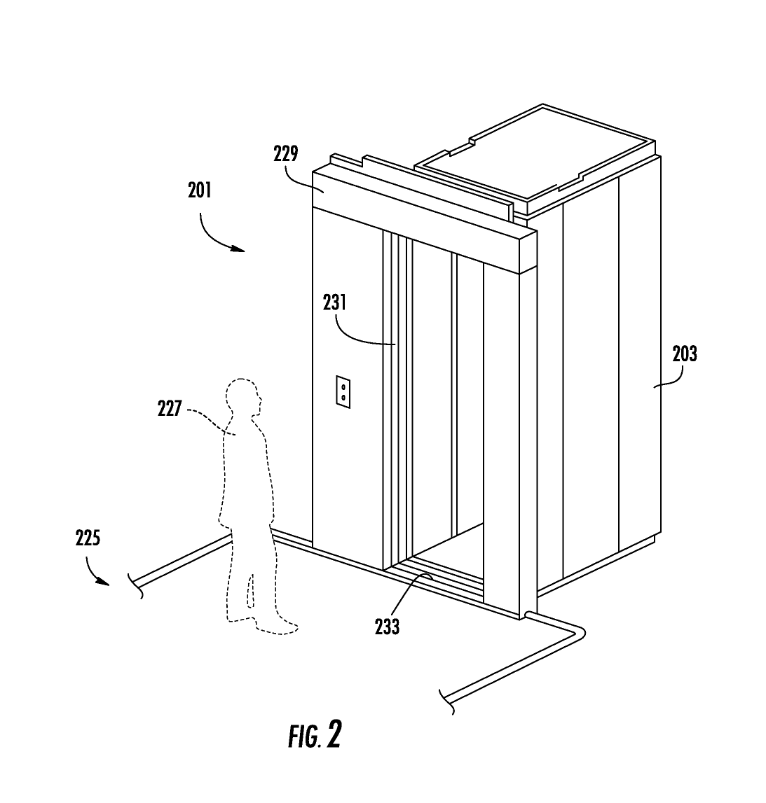

FIG. 2 is a schematic illustration of an elevator system 201 that may incorporate embodiments disclosed herein. As shown in FIG. 2, an elevator car 203 is located at a landing 225. The elevator car 203 may be called to the landing 225 by a passenger or mechanic 227 that desires to travel to another floor within a building or perform maintenance on a portion of the elevator system 201. A door lock can be provided in a landing door lintel 229 of the elevator system 201 (which may be located at one or more landings 225). The door lock in the landing door lintel 229 can be used to securely lock a landing door 231 to prevent unauthorized access to an elevator shaft. The landing door 231 is arranged to slide open and close along a landing door sill 233. The landing door sill 233 includes a guide, groove, or similar structure that is arranged to receive part of the landing door 231 to guide operation of the landing door 231.

In addition to being locked, landing doors of elevator systems are designed to withstand impacts to prevent forced entry or opening of the elevator landing doors, and thus prevent improper access to an elevator shaft. Thus, impact/shock resistance is provided for elevator landing doors to provide safety to passengers and prevent falls into the elevator shafts. To achieve this, the landing doors are arranged to remain in place and act as a barrier when the landing doors are closed. Typically, landing doors are reinforced with additional or heavy structural paneling that provides stiffness and strength to withstand impacts. For example, landing doors are typically made from sheet metal having relatively thin thickness (e.g., approximately 1.5 mm). Due to the thin metal of such landing doors, the panels typically require stiffeners or other structural reinforcement elements to withstand shocks and/or impacts.

It may be advantageous to provide stiff or safe sliding doors for automotive (e.g., vehicles) and/or elevators, for example. For example, improved structural stability, without increased weight, may be advantageous. For elevator sliding doors, e.g., landing doors and elevator car doors, can incorporate embodiments described herein while minimizing costs, weight, and installation time by reducing the weight and components thereof while maintaining secure and stiff structural landing doors. Embodiments described herein are directed to improving impact resistance of sliding doors (e.g., elevator system doors, vehicle sliding doors, building sliding doors, etc.). In accordance with some embodiments, an anti-derailment system having a stop located in or integrally formed with the sill of a sliding door system can be provided that enables increased strength or resistance to the sliding at the time of an impact or shock.

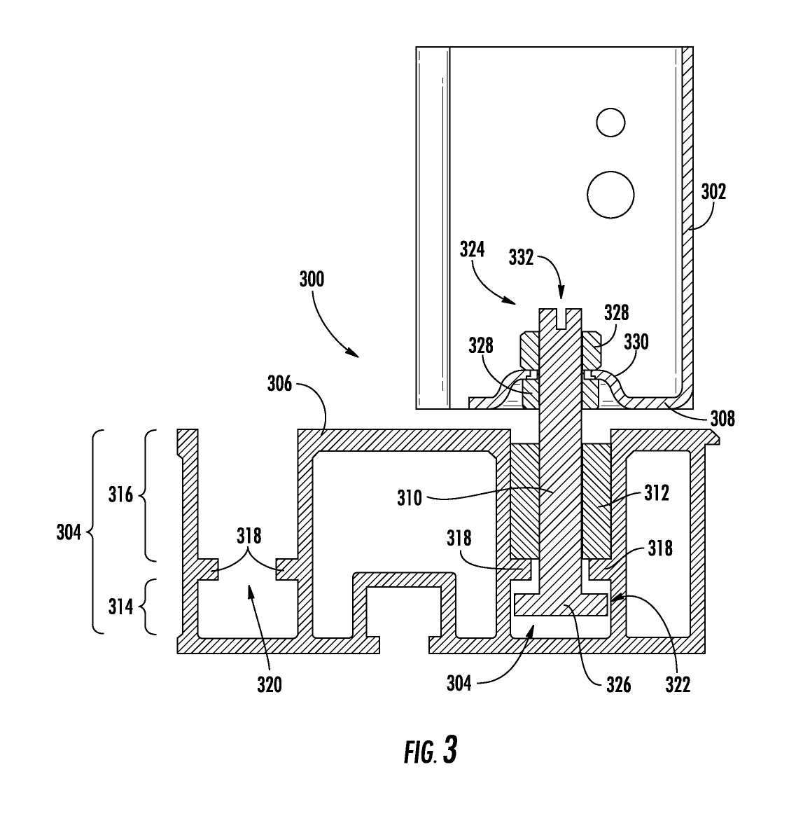

For example, turning now to FIG. 3, a schematic illustration of an anti-derailment system 300 in accordance with an embodiment of the present disclosure is shown. The anti-derailment system 300 is installed with or as part of a sliding door 302, such as an elevator landing door or elevator car door, which slides during operation. The sliding door 302 is arranged to be guided within a guide channel 304 of a sill 306 (e.g., a sill groove or sill channel). The sliding door 302 includes a panel base 308. The panel base 308 is a free end of the sliding door 302, with the sliding door 302 attached or suspended from an opposing end, as will be appreciated by those of skill in the art.

The anti-derailment system 300 includes a first member 310 and a second member 312. In the illustrative embodiment of FIG. 3, the first member 310 is a screw or bolt and the second member 312 is a gib shoe or guide shoe that attaches to or is configured about the first member 310. The first member 310 is arranged to provide anti-derailment functionality and the second member 312 is arranged to provide a sliding system to guide the sliding door 302 along the guide channel 304. The first member 310 is arranged to engage with the sliding door 302 and, in this embodiment, engage with and attached to the panel base 308.

As noted, the sill 306 includes one or more guide channels 304 that are arranged to receive a portion of the anti-derailment system 300 and provide a track along which the sliding door 302 is moved. In accordance with embodiments of the present disclosure, the guide channel 304 is subdivided into a first subchannel 314 and a second subchannel 316. The subchannels 314, 316 are partially separated by a stop 318. The stop 318 is defined, in this embodiment, by a flange or rail that runs along a wall of the guide channel 304 to separate the guide channel 304 into the subchannels 314, 316. In some embodiments, the stop may be integrally formed with the sill 306. The first subchannel 314 is arranged to receive a portion of the first member 310 and the second subchannel 316 is arranged to receive the second member 312. The stop 318 further includes or defines a gap 320 through which the first member 310 may pass to enter into the first subchannel 314.

The first member 310 has a first end 322 and a second end 324. A locking element 326 is located at the first end 322 of the first member 310. The locking element 326 is arranged to fit within the first subchannel 314 of the guide channel 304 and allow for clearance between surfaces of the locking element 326 and surfaces of the first subchannel 314 (e.g., prevent contact therebetween during normal operation). Further, the gap 320 is sized to allow for insertion of the first end 322, and the locking element 326 thereof, to pass therethrough during an installation process.

The second end 324 of the first member 310 is arranged to engage with the panel base 308. As shown, a securing mechanism 328 can be provided to securely attach the first member 310 to the sliding door 302. As shown, the securing mechanism 328 is arranged as a set of nuts that may be threadedly attached to the first member 310 with a portion of the panel base 308 engaged between the nuts. In some embodiments, the nuts of the securing mechanism 328 may be locking nuts, crimp nuts, etc. In various embodiments, locking nut, crimping nut, and/or lock-pin systems and/or arrangements can be employed to form the securing mechanism 328. As shown, the panel base 308 includes a recess 330 that is arranged to receive a portion of the securing mechanism 328. The recess 330 is arranged such that the securing mechanism 328 does not extend between the panel base 308 and the sill 306 and thus prevents contact therebetween.

The first member 310 further includes an indicator 332 at the second end 324. The indicator 332 is arranged to match or align with an orientation of the locking element 326 at the second end 322 of the first member 310. As such, the indicator 332 can provide an indication of an orientation of the locking element 326.

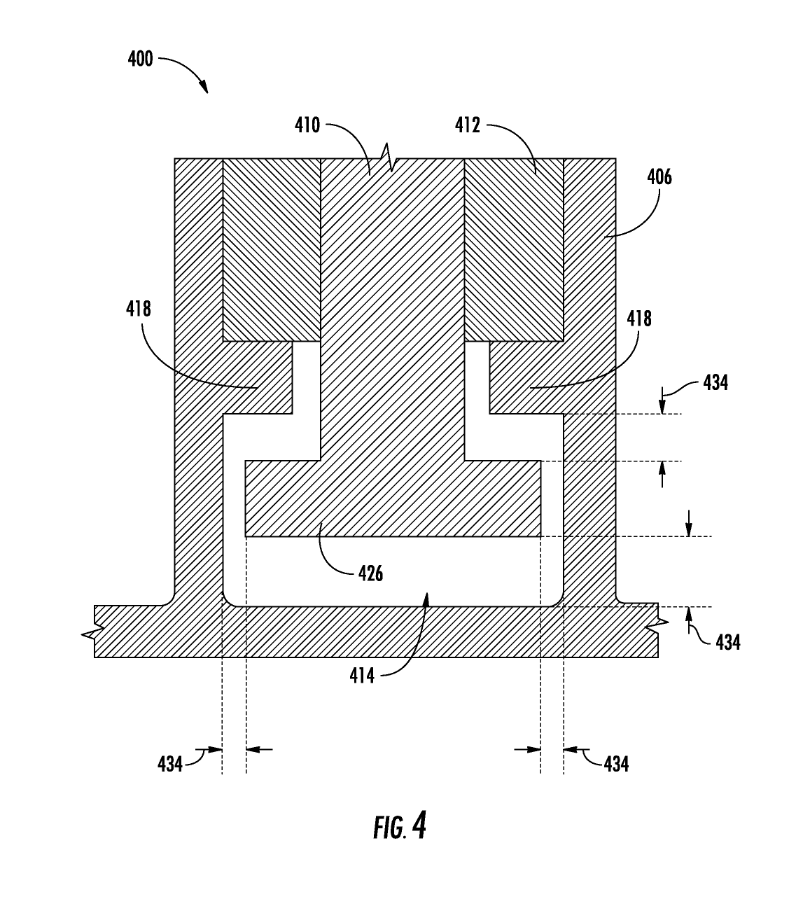

Turning now to FIG. 4, a schematic illustration of a portion of an anti-derailment system 400 in accordance with an embodiment of the present disclosure is shown. The anti-derailment system 400 is installed with or as part of a sliding door, similar to that shown and described above. The anti-derailment system 400 is arranged to guide the sliding door within a guide channel of a sill 406 (e.g., a sill groove or sill channel). The anti-derailment system 400 is installed at a free end of the sliding door, with the sliding door attached or suspended from an opposing end, as will be appreciated by those of skill in the art.

The anti-derailment system 400 includes a first member 410 and a second member 412, with a locking element 426 of the first member 410 positioned within a first subchannel 414, similar to that shown and described above. The first subchannel 414 is at least partially defined by a stop 418. When the locking element 426 is located within the first subchannel 414, the locking element 426 is arranged to move within the first subchannel 414 without contact such that a sliding motion of a sliding door is not impeded, although at times contact may occur without significant impact on operation. During an impact to the sliding door however, the locking element 426 is arranged to contact the stop 418 to prevent the first member 410, and the attached sliding door, from jumping out of a guide channel. As shown in the embodiment of FIG. 4, the locking element 426 has clearances 434 on all sides to allow for ease of movement through and along the first subchannel 414. However, if a force is applied to the sliding door to which the anti-derailment system 400 is attached, the locking element 426 will move into contact with the stop 418 and/or other surface of the first subchannel 414 to prevent the first member 410 from being removed from the guide channel and thus retain the sliding door in position relative to the guide channel.

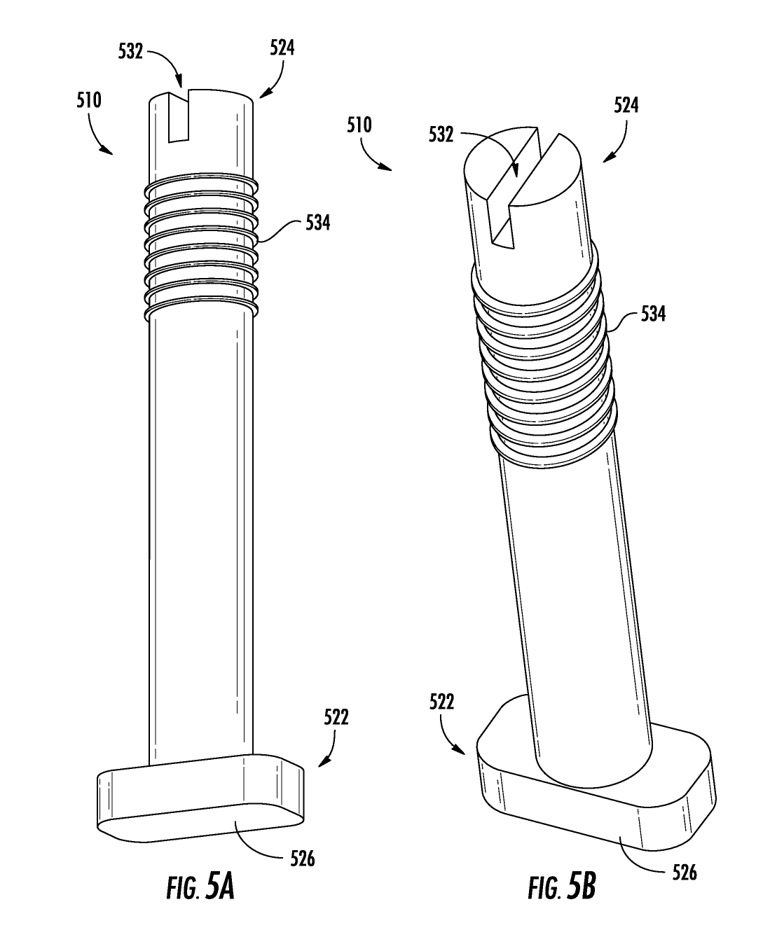

Turning now to FIGS. 5A-5B, schematic isometric illustrations of a first member 510 of an anti-derailment system in accordance with an embodiment of the present disclosure are shown. The first member 510 is arranged for installation to a sliding door and to be inserted into a guide channel to aid in guiding the sliding door along the guide channel and to prevent the sliding door from being moved or urged out of or away from the guide channel.

The first member 510 has a first end 522 and a second end 524. The first end 522 includes a locking element 526. The locking element 526 is shaped for insertion through a gap in a guide change and then rotation such that the locking element 526 is positioned to contact a stop if urged due to contact with a sliding door. The second end 524, in this illustrative embodiment, includes a threaded portion 534 that enables threaded engagement to a panel base and/or threaded engagement with one or more threaded nuts or other securing elements. Further, the second end 524 includes an indicator 532. The indicator 532 of the second end 524 is arranged to align with the locking element 526 located at the first end 522 and is configured to indicate or provide information regarding an orientation of the locking element 526. As shown, the indicator 532 is a slot formed in second end 524 of the first member 510. However, in other embodiments, the indicator 532 may be a groove or other marking, including painted on, a sticker, or other directional and/or orientation indicator, as will be appreciated by those of skill in the art. In some embodiments, the indicator 532 may be a structural feature that allows for engagement with a tool to enable turning or rotation of the first member 510.

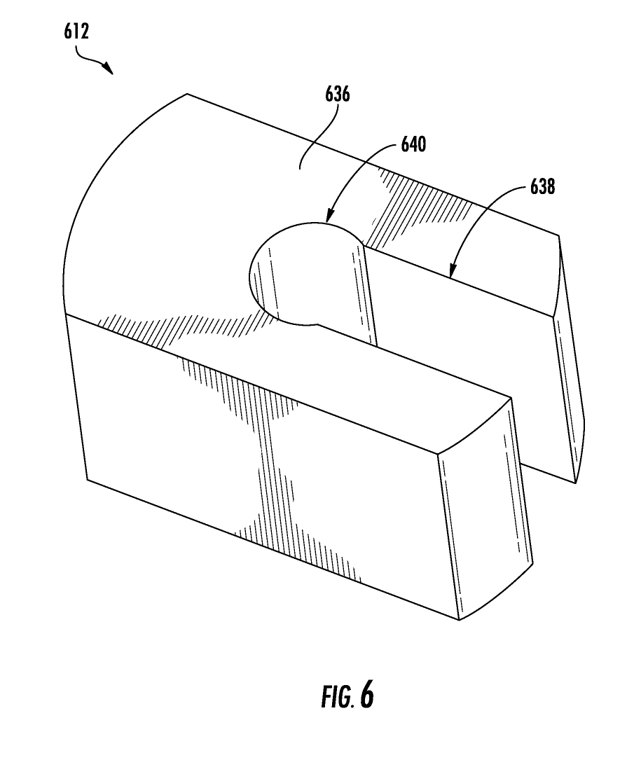

Turning now to FIG. 6, a schematic isometric illustration of a second member 612 of an anti-derailment system in accordance with an embodiment of the present disclosure is shown. The second member 612 of this illustrative embodiment has a clip-style arrangement, with a body 636 defining a receiving channel 638 and a receiving aperture 640. The body 636 is arranged to provide frictional engagement with a guide channel of a sill and to ensure appropriate sliding motion of a sliding door to which the second member 612 is connected. The receiving channel 638 is sized and shaped to enable a first member (e.g., as shown in FIGS. 5A-5B) to be installed through to the receiving aperture 640. The receiving channel 638 and the body 636 are arranged to retain the first member within the receiving aperture 640. In some non-limiting embodiments, the body 636 may be formed of a plastic or rubber material.

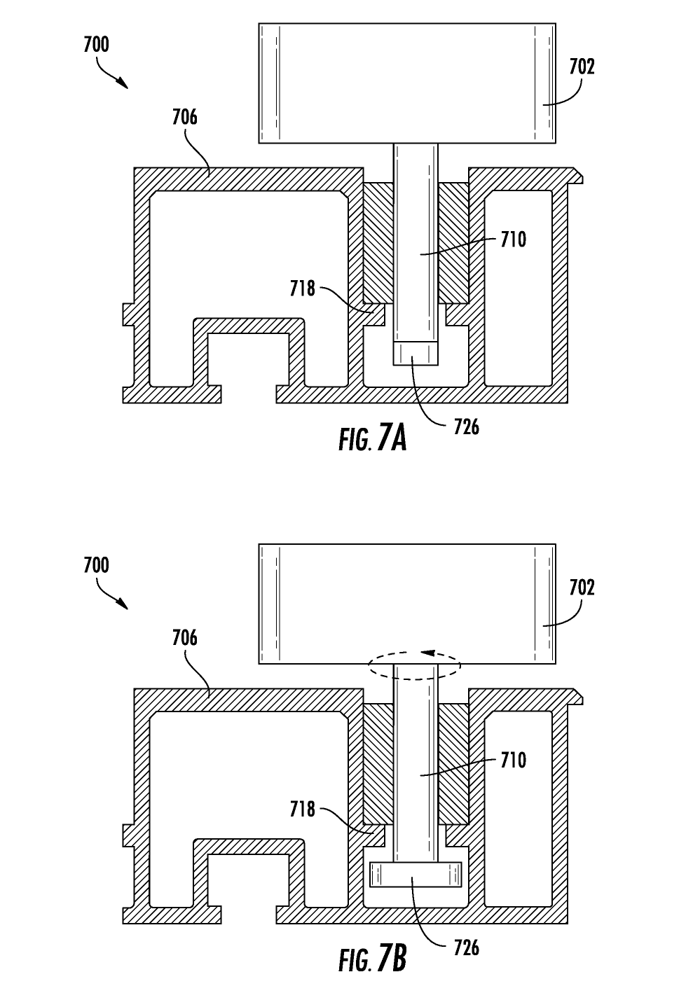

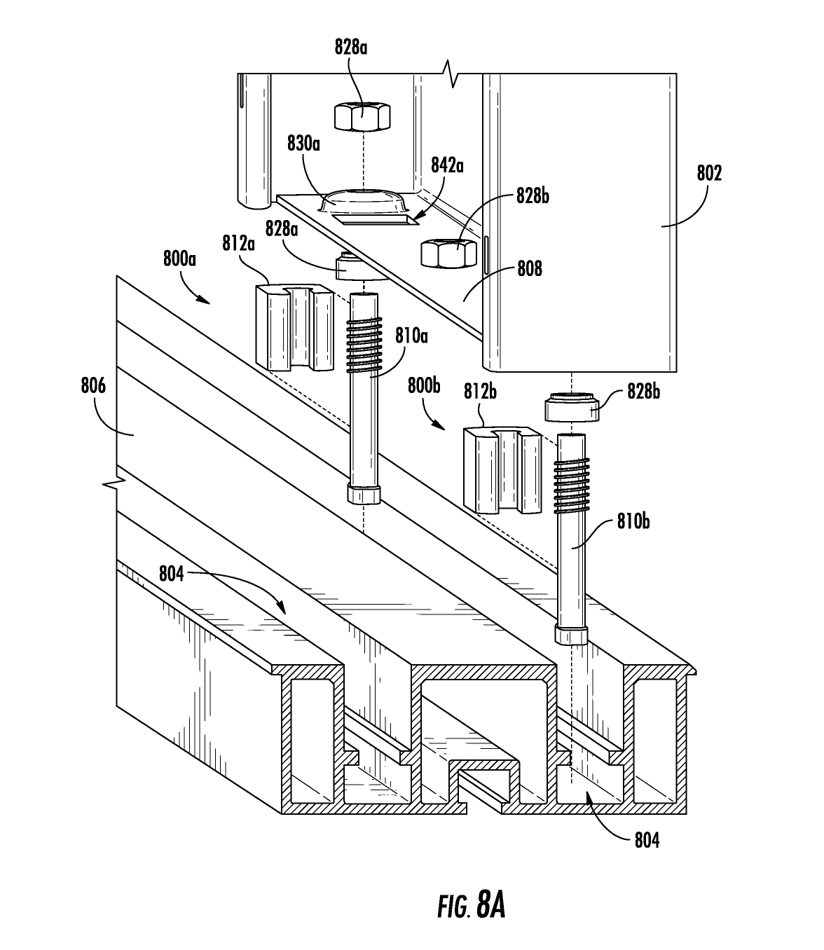

Turning now to FIGS. 7A-7B, schematic illustrations of part of an installation process of an anti-derailment system 700 in accordance with an embodiment of the present disclosure are shown. FIG. 7A illustrates a first orientation of a first member 710 of the anti-derailment system 700 for installation, and FIG. 7B illustrates a second orientation of the first member 710 of the anti-derailment system 700 as installed to prevent anti-derailment of a sliding door 702 to which the anti-derailment system 700 is attached. As shown in FIG. 7A, the orientation of a locking element 726 of the first member 710 is arranged to pass through a gap defined by a stop 718 within a guide channel of a sill 706, similar to that shown and described above. Once inserted through the gap of the stop 718, the first member 710 can be rotated to orient the locking element 726, as shown in FIG. 7B.

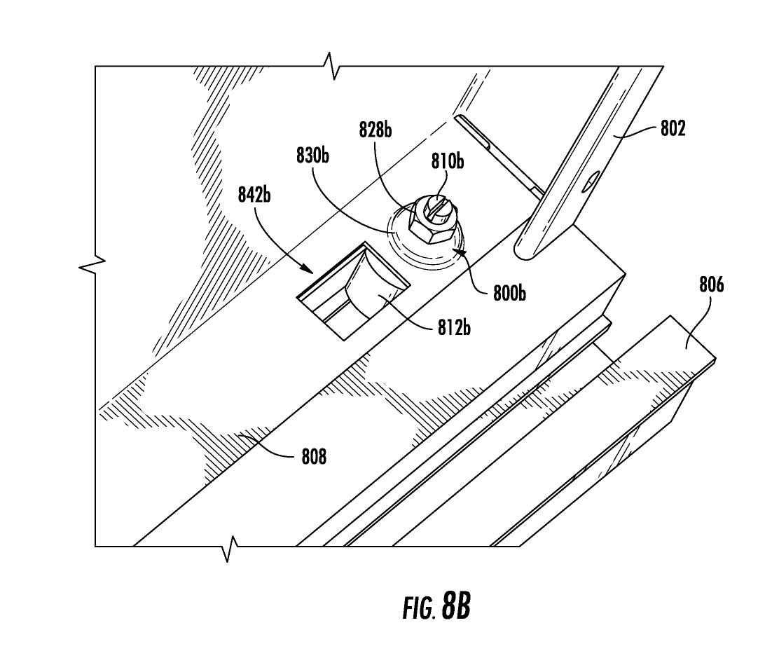

Turning now to FIGS. 8A-8B, schematic illustrations of installation of a first anti-derailment system 800a and a second anti-derailment system 800b to a sliding door 802 in accordance with an embodiment of the present disclosure are shown. The first anti-derailment system 800a includes a respective first member 810a and second member 812a that are installed to a panel base 808 of the sliding door 802. Similarly, the second anti-derailment system 800b includes a respective first member 810b and second member 812b that are installed to the panel base 808 of the sliding door 802. The first and second members 810a, 810b, 812a, 812b of the first and second anti-derailment systems 800a, 800b are inserted into a guide channel 804 of a sill 806 to guide the sliding door 802 in a sliding motion along the sill 806.

The first member 810a of the first anti-derailment system 800a is attached or connected to the panel base 808 by a respective securing mechanism 828a. Similarly, the second member 810b of the second anti-derailment system 800b is attached or connected to the panel base 808 by a respective securing mechanism 828b. As shown, in FIGS. 8A-8B, the securing mechanisms 828a, 828b are installed at respective recesses 830a, 830b of the panel base 808.

As shown, the panel base 808 includes an optional first inspection aperture 842a and an optional second inspection aperture 842b. The inspection apertures 842a, 842b are positioned to enable visual inspection of parts of the anti-derailment systems 800a, 800b.

Advantageously, embodiments provided herein provide a strong and secure mechanical interface that maintains a sliding door or door panel into a sill. Such secure mechanical interface is applicable regardless of a direction of effort applied on the sliding door/panel (e.g., an effort to derail the door from a guide channel). Further, advantageously, the anti-derailment systems of the present disclosure are adjustable (e.g., attach/install/adjust position, etc.). Moreover, advantageously, the anti-derailment systems of the present disclosure, or portions thereof, can be easily inspected, repaired, and/or replaced during maintenance operations.

Although shown and described specifically with respect to elevator sliding doors, those of skill in the art that embodiments of the present disclosure are not so limited. That is, the illustrative elevator arrangements shown and described herein are provided merely for example purposes. In some arrangements, the anti-derailment systems of the present disclosure can be incorporated into any type of sliding door that may require additional structural rigidity or strength, particularly to withstand impacts. Such sliding doors include, but are not limited to, public transportation sliding doors, such as on trains, subways, buses, or other sliding doors of vehicles, etc.

As used herein, the use of the terms “a,” “an,” “the,” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity).

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the spirit and scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

1. A sliding door system comprising:
a sliding door having a panel base;
a sill having a guide channel having a stop arranged within the guide channel, wherein the guide channel includes a first subchannel and a second subchannel, wherein the first subchannel is defined at least partially by the stop and wherein the stop defines a gap connecting the first subchannel to the second subchannel; and
an anti-derailment system comprising:
a first member having a first end and a second end, wherein the first end extends into the first subchannel and the second end connects to the panel base; and
a second member attached to the first member, wherein the second member is positioned within the second subchannel of the guide channel.

2. The sliding door system of claim 1, wherein the first member includes a locking element at the first end, wherein the locking element is arranged to contact the stop during an impact to the sliding door.

3. The sliding door system of claim 2, wherein the locking element does not contact the stop during normal operation.

4. The sliding door system of claim 2, wherein the locking element is arranged to pass through the gap in a first orientation and is rotatable to a second orientation within the first subchannel.

5. The sliding door system of claim 1, further comprising a securing mechanism, wherein the securing mechanism fixedly attaches the first member to the panel base.

6. The sliding door system of claim 5, wherein the panel base includes a recess, wherein at least a part of the securing mechanism is received within the recess.

7. The sliding door system of claim 5, wherein the securing mechanism comprises at least one of a locking nut system, a crimping nut system, and a lock-pin system.

8. The sliding door system of claim 1, wherein the first member includes an indicator located at the second end, wherein the indicator indicates an orientation of the first member.

9. The sliding door system of claim 8, wherein the indicator is aligned with at least a portion of the first end of the first member to indicate an orientation of the first end of the first member.

10. The sliding door system of claim 1, wherein the panel base includes at least one inspection aperture positioned to enable visual inspection of at least a portion of the anti-derailment system.

11. The sliding door system of claim 1, wherein the second end of the first member includes threads for engagement with at least one of the panel base and a securing mechanism.

12. The sliding door system of claim 1, wherein a second anti-derailment system is installed to the panel base.

13. The sliding door system of claim 1, wherein the second member frictionally engages within the second subchannel.

14. The sliding door system of claim 1, wherein the sliding door is at least one of a landing door and an elevator car door of an elevator system.

15. The sliding door system of claim 1, wherein the sliding door is a sliding door of a vehicle.

16. The sliding door system of claim 2, further comprising a securing mechanism, wherein the securing mechanism fixedly attaches the first member to the panel base.

17. The sliding door system of claim 3, wherein the locking element is arranged to pass through the gap in a first orientation and is rotatable to a second orientation within the first subchannel.

18. The sliding door system of claim 5, wherein the first member includes an indicator located at the second end, wherein the indicator indicates an orientation of the first member.

19. The sliding door system of claim 6, wherein the securing mechanism comprises at least one of a locking nut system, a crimping nut system, and a lock-pin system.

20. The sliding door system of claim 5, wherein the sliding door is at least one of a landing door and an elevator car door of an elevator system.
